(19) United States
(12) Patent Application Publication
(10) Pub. No.: US 2010/0235806 A1
(43) Pub. Date: Sep. 16, 2010

(54) Rich Web Site Authoring And Design

(75) Inventor: Bulusu Krishna Mohan, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/404,238

(22) Filed: Mar. 13, 2009

(51) Int. Cl. G06F 9/44

(52) U.S. Cl. 717/100

(57) ABSTRACT

Embodiments described provide web site design features and functionality, but are not so limited. In an embodiment, a computing system includes a design component that can be used to author rich web site templates. A user can use and modify aspects of a web site template as a model for a particular web site or other use. In one embodiment, a computing system includes a design component that can be used to author web site templates and/or a studio component that can be used to interact with and modify aspects of a web site template in creating a customized web site. Other embodiments are available.

### COPYRIGHT NOTICE

A portion of the disclosure of this patent document contains material, which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

### BACKGROUND

A web page designer can use available web page design tools to construct pages for a website. However, many of the available web site design tools provide limited functionality for a web site designer. Additionally, some web site design tools require that an end-user have at least some understanding of a computer language and associated functionality. As such, computer users lacking in a certain level of computing knowledge may be unable or unwilling to use available web site design tools.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments described herein provide web site design features and functionality, but are not so limited. In an embodiment, a computing system includes a design component that can be used to author rich web site templates. A user can use and modify aspects of a web site template as a model for a particular web site or other use. In one embodiment, a computing system includes a design component that can be used to author web site templates and/or a studio component that can be used to interact with and modify aspects of a web site template in creating a customized web site. Other embodiments are available.

These and other features and advantages will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 is a block diagram of an example computing environment having components that can be configured to provide rich web site authoring, design, and other functionality.

FIG. 2 is a block diagram of an example computing system having components that can be configured to provide a rich web site template.

FIG. 3 is a flow diagram illustrating an exemplary process of authoring a rich web site template.

FIG. 4 is a flow diagram illustrating an exemplary process of using a rich web site template to create a customized web site.

FIGS. 5A-5B depict an exemplary studio component user interface (UI).

FIG. 6 depicts an exemplary customized web site.

FIG. 7 is a block diagram illustrating an exemplary computing environment for implementation of various embodiments described herein.

### DETAILED DESCRIPTION

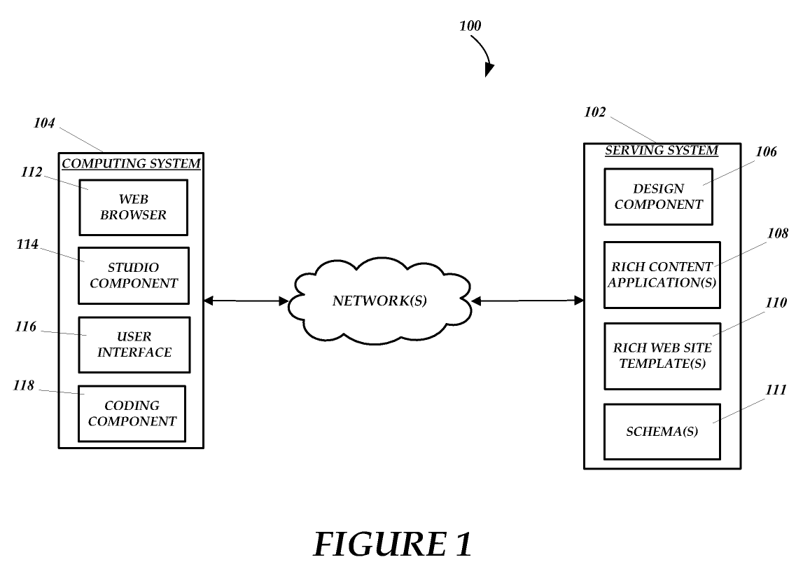

FIG. 1 is a block diagram of an exemplary computing environment 100 having a number of components that can be configured to provide rich web site features and functionality, but is not so limited. In accordance with various embodiments, components of the computing environment 100 can be used to author aspects of a rich web site template that can be used to create a customized web site, as described below. For example, a web site developer can use features of a rich web site authoring tool to author web site templates having rich content and controls.

As described below, and in accordance with one embodiment, components of the environment 100 can include one or more schemas having a number of site properties and values that can be used to define a rich web site template and/or a customized web site. Additionally, one or more schemas, such as XML based schemas for example, and one or more application programming interfaces (APIs) can be used to generate one or more data structures representative of aspects of a rich web site template, and/or a customized web site that is based on the rich web site template used in generating the customized web site.

For example, one or more APIs can be used to bind, link, or associate template properties with attribute values of one or more schemas. APIs can also be used to provide various methods, described below, that can be used to control aspects associated with a rich web site template. In one embodiment, a web site template and/or a customized web site template can be stored as one or more data structures as part of local and/or remote memory. Additionally, rich web site templates (or links to the templates) can be posted on a dedicated web site and stored in memory of a dedicated server or other store. For example, after creating a rich web site template, the template developer or author can upload the template which can then be accessed and used by the public, a group of users, or an individual.

Each rich web site template can be designed and associated with a particular source, service, product, etc., and thereafter customized by a consumer according to a particular preference or web site theme. In one embodiment, a rich web site template can be tailored to a particular entity, a service, product, etc. As an example, a business owner that provides computer repair services can use a rich web site template having desirable features, content, and/or layout as a starting point or model when designing a web site to advertise the repair services. In one embodiment, one or more rich web site templates can be downloaded or pushed to a computing device or system for further use and/or modification, and/or accessed and used remotely using a computing network, such as the Internet for example.

As shown in FIG. 1, the computing environment 100 includes a serving system or component 102 and an end-user computing system 104 each including at least one processor and memory, and in communication with one another using one or more networks, but is not so limited. While one computing system 104 and serving component 102 are shown, the computing environment 100 is not so limited and can include any number of such systems and other components. For example, the computing environment 100 can include a serving system in communication with a plurality of user computers, such a number desktops, laptops, portable devices, etc. Other applications can also be included with the computing system 104, such as an operating system, a word processing application, an email application, a calendar application, etc. Additionally, component functionality can be further combined or divided.

In an embodiment, the serving component 102 includes a design component 106, a number of rich web site applications 108, a number of rich web site templates 110, and/or a number of schemas 111, but is not so limited. As described below, the number of rich web site templates 110 can be designed by a template author or designer and stored in memory that is associated the serving component 102 or some other local or remote storage. For example, the rich web site applications 108, rich web site templates 110, and/or other components can be implemented based in part on the rich presentation and other features included with a SILVERLIGHT application download. SILVERLIGHT features can be used to provide rich web site features, such as rich web site content and controls. Professional designers can use a design tool (e.g., Expression Blend® application(s)) and professional developers can use a coding tool (e.g., Visual Studio® application(s)) to create and edit SILVERLIGHT content.

For example, the design component 106 can be included with or downloaded to the computing system 104 and used in conjunction with the coding component 118, such as Visual Studio® by Microsoft® Corporation for example, to create one or more projects corresponding to the designing of one or more rich web site templates. In one embodiment, the design component 106 can be compiled using an assembly file downloaded from a dedicated service, such as a web site authoring platform that can be used in conjunction with the SILVERLIGHT program(s).

In an embodiment, the computing system 104 includes a web browser 112, a studio component 114, a user interface (UI) 116, and a coding component 118, but is not so limited. While a number of exemplary components are shown, the computing system 104 can include fewer or additional components and other features. As described below, the studio component 114 can be used in conjunction with a rich web site template to create a customized web site. In the example of FIG. 1, and in accordance with an embodiment, the studio component 114 is included with the computing system 104.

In another embodiment, the studio component 114 can be configured as a web-based application and accessed using the web browser 112. For example, features of the studio component 114 can be presented in the UI 116 when loading a web site template in the web browser 112 as part of the web browser interface or as a separate interface. In various embodiments, the studio component 114 can be configured to include a number of rich tools and features that can be used to create and generate a customized web site using one or more rich web site templates 110 as a model. In one embodiment, the studio component 114 can operate to present relevant modification tools based in part on aspects of a web site template being used, such as a selected modifiable element or property of the template for example.

As described briefly above, the design component 106 can be used by a user, such as template author or designer for example, to create one or more web site templates having rich features. As described below, and according to an embodiment, a template author can create/design the following features used as a basis for a rich web site template: 1) Master.xaml: An extensible application markup language (XAML) file that provides xaml for a master page that is applied to all the pages of a rich web site template and/or customized web site (optionally, the template author may provide an associated code-behind file, to expand beyond a declarative framework); 2) PropDesc.xml: an extensible markup language (XML) file that describes metadata for all customizable properties of a master page; and, 3) default content: provided as a starting point, wherein the default content can be modified as the user edits/customizes aspects of rich web site template as part of creating a customized web site, but is not so limited. In one embodiment, default data includes three components, but is not so limited: a) SiteData.xml: An XML file that provides default values for customizable properties of the rich web site template (the file content changes as a user customizes certain properties); b) ContentPage.xaml: a separate instance of this file is included for each web site page; and, c) Resource file(s) such as images, videos, etc.

In one embodiment, the computing system 104 may not include a coding component 118 and/or design component 106 for a user who is uninterested in creating a rich web site template. For example, a web site developer can download the design component 106 which can be used in conjunction with the coding component 118 to design and generate web site templates. The web site templates can be posted on a web site for further use in creating a customized web site that includes rich content and controls, as discussed briefly above.

In accordance with one embodiment, web site authoring functionality can be coded and included as part of the design component 106. For example, the design component 106 can include the following authoring features that can be programmed as executable instructions, which when executed, provide design tools that can be used when designing rich web site templates. Assume for the following example that the design component 106 comprises a platform component or software development kit (SDK), and a XAP file, such as one or more files of the SILVERLIGHT application for example. The design component 106 can be used to implement aspects of the web site template creation and/or modification process, wherein the XAP file includes an application manifest file (e.g., AppManifest.xaml) and any data link libraries (DLLs) required by the application.

For this example:

using System;

using System.Collections;

using System.Collections.Generic;

using System.IO;

using System.Linq;

using System.Net;

using System.Reflection;

using System.O/S;

using System.Browser;

using System.Controls;

using System.Documents;

using System.Input;

using System.Markup;

using System.Media;

using System.Media.Imaging;

using System.Media.Animation;

using System.Resources;

using System.Shapes;

using System.Xml;

using System.Xml.Linq;

namespace Author

In an embodiment, the namespace includes a base class (e.g., AuthorMasterPage class) which defines a base class of properties and attributes that can be used to author rich web site templates, but is not so limited. As described below, and in accordance with one embodiment, each rich web site template can be authored or designed to include a master page that provides the design and/or content elements common to each page of the rich web site template derived in part using the base AuthorMasterPage class. The AuthorMasterPage class can also be used to create and/or edit pages of a web site, such as by using the studio component 114 for example. As described below, the studio component 114 can be configured with web site design functionality that can be used to insert/edit/delete text, images, tables, special-purpose controls, and/or other visual and/or interactive elements of the web page, change the layout of page content, insert/edit/delete audible features, insert/edit/delete video features, etc.

The AuthorMasterPage class provides functionality at browse-time as well as at design-time. For example, at design-time, the AuthorMasterPage page class (and other related classes associated with a studio component 114, referred to as AuthorStudio of one example described further below) can be used to provide a user interface that a template consumer can use to manipulate aspects of a web site template, such as values associated with a number of site design properties that have been defined by a template author or designer.

As another example, at browse-time, a base master page (e.g., of the AuthorMasterPage class) includes logic or features to parse files, such as XML based files for example, and/or associate or link property values with corresponding visual elements of a given web site. In one embodiment, a base master page can be configured to parse a property description file (see the example propdesc.xml file below) and a site data file (see the example sitedata.xml file below), including ensuring that property values are used for corresponding visual and/or interactive elements of a web site. A base master page can also be configured with additional logic or features to render a navigation bar and provide the navigation functionality, such as enabling a user to switch among different pages of a web site. In one embodiment, each web site template and any customized web site can be configured to include a single-page web site comprising the base master page, wherein the web browser is not required to navigate in response to clicking on links in the navigation bar.

A number of member data variables can be used to maintain useful state information, such as, but not limited to: any site data; property description(s) (e.g., propdesc.xml); currently active/selected web page; a root element of the active/selected page; and/or, a root element associated with content of the active/selected page. In an embodiment, the root element of a page acts as the container for all the other elements in the page. Stated differently, the page is the “root” element of a “page element tree”. Likewise, the root element of the page content is the container of all those elements in the page which did not result from a master page. As such, the “page content element tree” is a sub-tree within the “page element tree”. Everything within this sub-tree is unique to a specific page, whereas everything outside this sub-tree is common to all the pages of a particular web site. In one embodiment, the customizable content of a web page of a rich web site template can be defined as portions of a web page excluding the “design” or fixed portion(s) common to all pages of the web site created with the design component 106.

In one embodiment, the AuthorMasterPage component can be configured to read and link the site data (e.g., from sitedata.xml) and property descriptions (e.g., from propdesc.xml) using the XAP file as a page is loaded in a web browser or other component. The AuthorMasterPage component can include or call a number of methods can be used at design time and/or at browse time using the base class.

A number of exemplary methods include, but are not limited to:

A Page_Loaded method can be used/called when the web browser has finished loading a page and includes calls to a LoadSiteData method (see below) to set up a navigation bar and the design properties of a web page based in part on values of site data corresponding to parameters of a property description schema. For example, the web browser can load a page or a portion of a page from a local or a remote storage medium and the studio component can operate to render a navigation bar and/or design properties of a web page, based in part on values of default and input site data to modify properties of the rich web site template.

In one embodiment, the Page_Loaded method can be configured to detect user selection actions, such as mouse clicks, verbal commands, pen select, touch commands, etc. as part of a customizing a web site template when a user interacts with portions or elements of a web site or web site template. For example, the method can detect mouse clicks or other selection events based in part on values of a click-on attribute for a corresponding property or properties included in the property description manifest, such as a property description file for example.

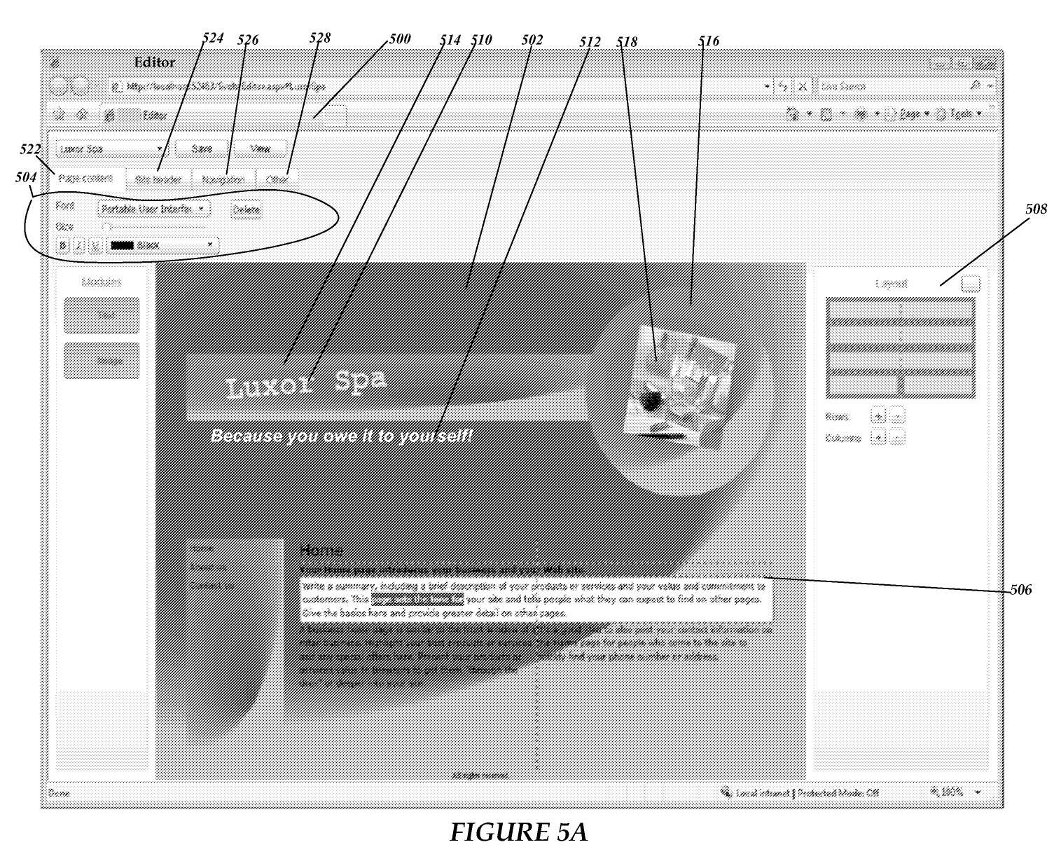

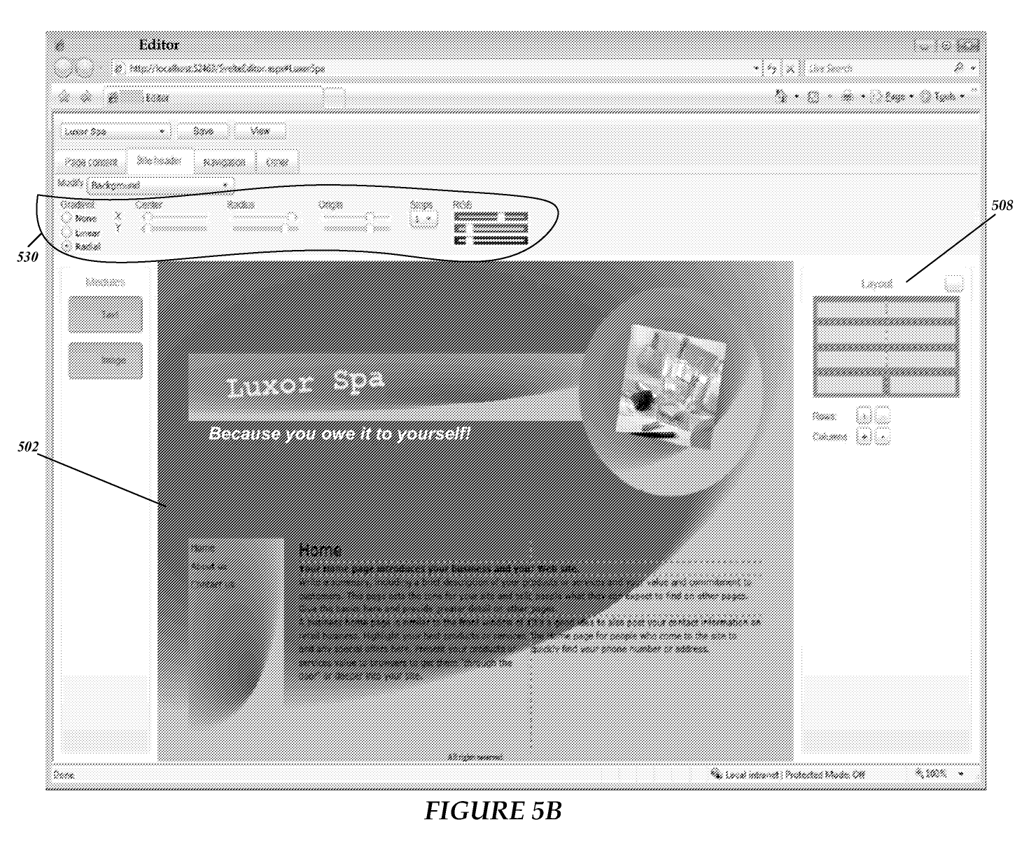

The foregoing and other detection methods can be used or called when a user clicks or otherwise interacts with an element or portion of a web page template which, in turn, operates to activate an appropriate UI editing tool or tools, such as a tool ribbon for example, corresponding to a clicked element that includes an associated property type. For example, a detection method can be configured to, based in part on a detected action, operate to activate a modification ribbon or tool ribbon that includes a number of tool elements. In one embodiment, a modification ribbon can include editing tools that have been defined or delineated by a template author to be presented for a corresponding property type (see the examples of FIGS. 5A-5B). For example, editing tools for an image type may include a tool to modify the orientation of the image, but the template author may choose to disallow that tool from being displayed because he does not want the template consumers to modify the orientation of an image.

The GetContentStream method can be configured to extract a resource file stream from the XAP file.

The LoadXmlFromXap method can be configured to extract an XML file, such as an XML document for example, from the XAP file. For example, this method can be used to extract XML property description and site data files from a XAP file that has been downloaded from a SILVERLIGHT web site.

The LoadSiteData method can be configured to: call/use the LoadPropertiesFromSiteData method (see below) to set up design properties of a page based in part on the site data and the property descriptions; call/use the LoadNavigation method (see further below) to set up a navigation bar; and/or call/use the SetCurrentPage method (see below) to activate a default web page.

The LoadPropertiesFromSiteData method can operate to examine each design property as specified in the site data and the property descriptions and call/use the UpdateSiteProperty method based on identified design properties.

The GetBrushFromSiteData method can operate to create a brush object from the value specified in the site data, honoring brush-specific attributes.

The GetNumberFromSiteData method can operate to compute a number from a value specified in the site data.

The LoadImagePropertyFromSiteData method can operate to create an image object from a value specified in the site data, honoring image-specific attributes.

The LoadTextPropertyFromSiteData method can operate to create a text object from a value specified in the site data, honoring text-specific attributes.

This example also includes a number of virtual methods including, but not limited to:

The UpdateSiteProperty virtual method can be configured to: identify a target visual element based in part on a bind-to attribute as specified in the property descriptions; set attribute values of a target element based on the property attribute values specified in the site data; and/or use/call specific assisting methods, such as a type-specific assisting method based on the type of each property for example, and/or other methods, as part of an operation, but is not so limited. In one embodiment, this virtual method can be overridden to perform custom handling.

The LoadNavigation virtual method can be configured to examine a list of web pages as specified in the site data, and bind each page to a navigation control as specified in the web site master page XAML.

The SetCurrentPage method can be configured to: use/call GetContentStream to read the content of a web page from a XAP file; set up member variables for state information of the root element for example; and/or, update a navigation bar to highlight a corresponding hyperlink, but is not so limited.

As discussed above, a user can use the studio component 114 and a rich web site template designed with the design component 106 to create a customized web site. In one embodiment, the studio component 114 includes custom tools determined by the template designer, wherein the custom tools can be presented based in part on the type of property being modified/edited. For this example, the studio component 114 includes, but is not limited to an AuthorStudio namespace that includes an AuthorEditor class. The AuthorEditor class can be defined to include member data variables to maintain various state information, but is not so limited. In one embodiment, the class can include member data variables to maintain various state information including, but not limited to: a location of the web site or template being edited; an instance of the AuthorMasterPage in the web site or template being edited; a state of the editing tools, such as ribbon tools for example; and/or an element of a web site page currently being edited.

In an embodiment, the studio component 114 can include an AuthorEditor component that can be configured to add a listener or detection method to detect and/or wait until the editor UI (see the exemplary editor UI of FIGS. 5A-5B) is loaded. The AuthorEditor component can also include or use a number of additional methods as part of a customizing a web site template for a particular entity, service, product, etc. According to one embodiment, the AuthorEditor component can also be used to design new rich web site templates based in part on an original rich web site template. However, in accordance with such an embodiment, certain aspects of the original web site template may not be modifiable based in part on the underlying design.

Exemplary methods called/used by the AuthorEditor component include, but are not limited to:

The Page_Loaded method can be called/used upon loading an editor UI (see exemplary modification UI 500 of FIGS. 5A-5B) to, but is not so limited: determine and load the web site or web site template that the user intends to modify; set up one or more listeners or detection methods for click/change events on one or more ribbon elements in one or more tool ribbons (text ribbon, image ribbon, brush ribbon, etc.); hook up or associate a selection change event of a control, such as dropdown control of a web site for example; and/or, detect and respond if the user chooses to edit a different web site or template. For example, the user can use the web browser 112 to locate a desirable web site template or load a default web site template from local or remote storage, and the Page_Loaded method can load the web site and associated interface characteristics and controls in the web browser 112 or other component.

The CurrentProperty method can be configured to get or set the property that a user is currently editing.

The CurrentRibbon method can be configured to get or set a ribbon that can be used to edit the current property. As described above, and in accordance with an embodiment, the editor UI can display a distinct ribbon having modification tools based in part on the property type under consideration for modification.

The InsertModule_MouseLeftButtonDown, InsertModule_MouseMove, and InsertModule_MouseLeftButtonUp methods provide functionality to support drag-drop of various types of elements (text, image, audio, video, etc.) from a toolbox provided with the editor UI (see examples of FIGS. 5A-5B) to include with the page content, resulting in insertion of the element in the page, to thereby allow a user to quickly and efficiently add content corresponding to a defined property of the web site or web site template.

The AddContentColumn_Click, AddContentRow Click, DeleteContentColumn_Click, DeleteContentRow_Click, ContentLayoutCell_MouseMove, ContentLayoutCell_MouseLeftButtonUp, ContentLayoutCell_MouseLeftButtonDown, ContentLayoutCell_MouseLeave, and ContentLayoutCell_MouseEnter methods provide functionality to support modifications (e.g., adding/deleting/rearranging rows/columns/cells, etc.) of a layout modification tool, such as panel or grid (see 508 of FIGS. 5A-5B) for example, and/or modify the page content layout.

The FillFontFamilyCtl method can operate to load the font dropdown with available font families.

The FillFontColorCtl method can operate to load the font dropdown with the available font colors.

The InitContentLayoutGrid method can operate to initialize a layout panel to match the layout of the page content.

The UpdateTextRibbon method can operate to update a state of the text ribbon to match that of a selected text element.

The UpdateImageRibbon method can operate to update a state of the image ribbon to match that of a selected image element.

The UpdateBrushRibbon method can operate to update a state of the brush ribbon to match that of a selected brush element.

The UpdateNumberRibbon method can operate to update a state of the number ribbon to match that of a selected number element.

The GetBrushXaml method can be used to define XAML for a particular brush.

The SiteList_SelectionChanged method can operate to handle a user operation/selection to edit a different web site or web site template.

The ViewSite_Click method can operate to handle a user operation to browse (in a new browser window) to a web site or web site template being edited.

The SaveSite_Click method can operate to handle a user operation to save all the changes made to the web site or web site template being edited.

The NavItemClicked method can operate to handle a user operation to activate a different page in a web site and can be called/used when a user clicks on a navigation hyperlink in the navigation bar and switches the site to activate the web page that the hyperlink points to.

The ExpandCollapseLayout Click method can operate to handle a user operation to show or hide a layout panel of the editor UI.

The RibbonTabCtl_SelectionChanged method can operate to handle a user operation to switch to a different property group.

The PropsCombo_SelectionChanged method can operate to handle a user operation to present an editing or modification ribbon for a different property in the current property group being considered for modification or modified.

The TextCtl_TextChanged method can operate to handle a user operation to change the content of a text element.

The FontColorCtl_SelectionChanged method can operate to handle a user operation to change the font color of a text element.

The FontFamilyCtl_SelectionChanged method can operate to handle a user operation to change the font family of a text element.

The FontSizeCtl_ValueChanged method can operate to handle a user operation to change the font size of a text element.

The DeleteText_Click method can operate to handle a user operation to delete a text element.

The ImageYCtl_ValueChanged method can operate to handle a user operation to modify the vertical position of an image.

The ImageXCtl_ValueChanged method can operate to handle a user operation to modify the horizontal position of an image.

The ImageOpacityCtl_ValueChanged method can operate to handle a user operation to modify the opacity of an image.

The ImageRotateCtl_ValueChanged method can operate to handle a user operation to modify the orientation of an image.

The ImageHeightCtl_ValueChanged method can operate to handle a user operation to modify the height of an image.

The ImageBrowseCtl_Click method can operate to handle a user operation to load the image from a different image file or location.

The DeleteImage_Click method can operate to handles a user operation to delete an image element.

The ColorValueChanged method can operate to handle a user operation to modify the color of a brush element.

The GradientType_Checked method can operate to handle a user operation to modify the gradient type of a brush element.

The RadialXY_ValueChanged method can operate to handle a user operation to modify the origin of a radial gradient brush element.

The GradientStops_SelectionChanged method can operate to handle a user operation to select a different gradient stop to edit for a brush element.

The NumberSlider_ValueChanged method can operate to handle a user operation to change the numeric value of a visual property.

While a number of methods and components have been described above, other methods, components, and/or functionality can be implemented in other embodiments.

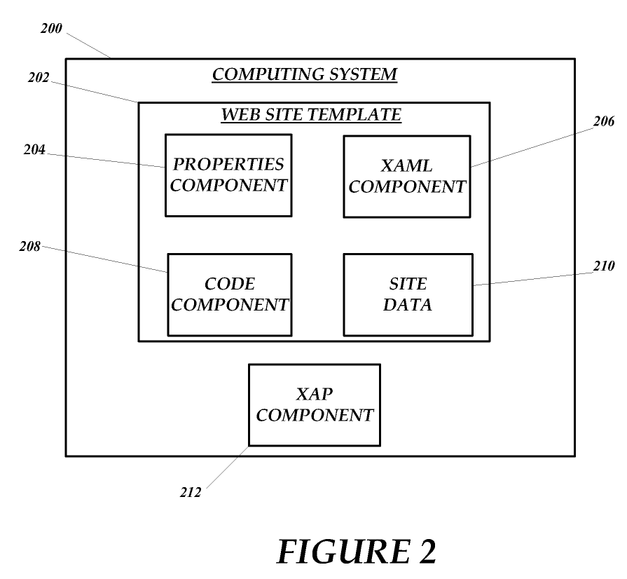

FIG. 2 is a block diagram of an example computing system having components that can be configured to provide a rich web site template and other functionality. In one embodiment, the computing system 200 can be configured as a dedicated server having associated components that can be used to provide rich web site templates, such as the rich web site template 202. As described above, a designer or template author can use a software development kit, such as design component 106 for example, or other application(s) to design a web site template that includes rich design features.

Assume for the example of FIG. 2 that a template author has designed the rich web site template 202 for a particular advertising target, service, product, user, etc. In one embodiment, the rich web site template 202 can be configured using a properties component 204, XAML component 206, code component 208, and site data 210, but is not so limited. The computing system 202 also includes a XAP component 212, such as a SILVERLIGHT application for example, that can be used with the rich web site template 202 to provide rich interactive web site features and other functionality. In alternative embodiments, functionality of various components can be combined or further divided.

In an embodiment, the properties component 204 can be generated using a schema of property types and associated attributes. For example, a template author can use the schema to generate a properties description XML file that includes one or more of a text property, a number property, an image property, a brush property, an enum property, an audio property, and/or a video property. A template author can use various properties and associated attributes to define a particular rich web site template, wherein each property type supports certain common metadata attributes.

Additionally, each property type can support additional metadata attributes, specific to the type. A property value can also include corresponding attributes. In one embodiment, metadata attributes are set by the template author and help to define the nature of an associated property and cannot be modified by a template consumer whose interactions are limited in some cases to modifying or setting value attributes.

Common metadata attributes corresponding to each property type include, but are not limited to: the DisplayName metadata attribute which can be used to denote a property name displayed in an editor or modification interface; the click-on metadata attribute corresponding to a modifiable property, such as a visual element or portion of a web page template for example, that if clicked or otherwise selected, operates to activate a ribbon or modification UI for editing the modifiable property; and/or the bind-to metadata attribute to bind the property value to the attribute of the visual element or portion of the rich web site template.

According to one embodiment, the text property can be used to define a fragment of text having some formatting (e.g., font, color, size, etc); the number property can be used to define a number within a specific min-max range; the image property can be used to define a picture or other graphical representation including width, height, orientation, transparency, and/or other parameters; the brush property can be used to define a color, or combination of colors, applied in a certain way over an area or portion; the enum property can be used to define a specific list of values (e.g., an enumeration); the audio property can be used to define an audio clip or other audio representation; and/or, a video property can be used to define a video clip or other video representation. Other properties and/or other metadata attributes can also be defined.

Additional meta attributes supported by the various property types include, but are not limited to (property: attribute(s)):

Text: MaxLength; AllowUserToSetFont.

Number: MinValue; MaxValue.

Image: RetainAspectRatio; AllowRotation.

Brush: AllowGradients.

Enum: The list of allowed values.

Audio: MaxSize; AllowedFormats.

Video: MaxSize; AllowedFormats.

In one embodiment, additional attributes of property values include, but are not limited to (property value: attribute(s)):

Text: Text; FontFamily; FontSize; FontColor.

Number: NumericValue.

Image: ImageSourceFile; Width; Height; Rotation (angle); Transparency.

Brush: BrushType (e.g., SolidColorBrush, LinearGradientBrush, RadialGradientBrush, and combinations thereof) that include a number of attributes including red/green/blue (RGB) color space and other values specific to each brush type.

Enum: One of the values from the list provided.

Audio: AudioSourceFile.

Video: VideoSourceFile.

Correspondingly, a template author can use various functionality described above to construct a rich web site template including controlling or defining the template user's experience when using the rich web site template 202 as a model to create or design a customized web site. The template consumer can use various user-friendly controls to modify aspects of the rich web site template when creating a particular web site. For example, a template author can control which template properties are allowed to be modified and/or the tools or ribbons associated with a modifiable property that are ultimately presented to the template consumer according to a given web site template.

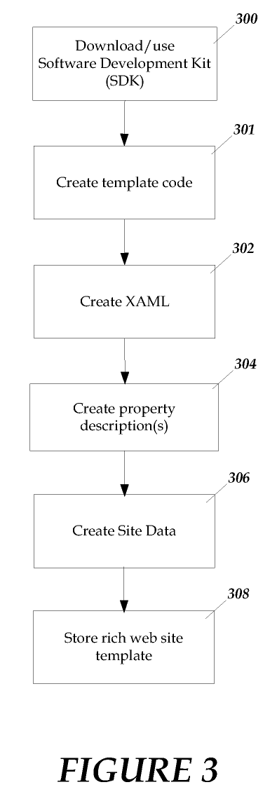

FIG. 3 is a flow diagram illustrating an exemplary process of designing a rich web site template. While a number and order of operations are shown and described, other embodiments are available. At 300, a template designer or author, can download a software development kit (SDK) from a web site, such as a SILVERLIGHT web site. In one embodiment, the SDK can be used with a coding tool, such as Visual Studio® by Microsoft® Corporation, to design rich web site templates. For example, template authors can design rich web site templates according to a third party requirement, preference, or association.

At 301, the template author can create a code file that defines a namespace and other features of the rich web site template, wherein the namespace or class is derived from a master namespace or class defined in the SDK. In one embodiment, the template author can also define executable methods that are to be used with a rich web site template. At 302, the template author can create a XAML file that defines controls on a page of a rich web site template. For example, the template author can define: brush-based controls that are presented when a template consumer selects a modifiable element corresponding to the brush controls; text-based controls that are presented when a template consumer selects a modifiable element corresponding to the text controls; image-based controls that are presented when a template consumer selects a modifiable element corresponding to the image controls; audio-based controls that are presented when a template consumer selects a modifiable element corresponding to the audio controls; video-based controls that are presented when a template consumer selects a modifiable element corresponding to the video controls, etc.

At 304, the template author can create a number of property descriptions (e.g., a property description XML file) that define a number of properties that can be used to control aspects of the rich web site template, including corresponding modification controls (e.g., ribbon(s)). For example, the template author can select from a number of available property types when using the SDK to design the rich web site template. As one example, the property description file can also include a number of property attributes that can be associated with each property type to define user modification results.

At 306, the template author can create a site data file that includes site data defining content of the rich web site template. In one embodiment, the site data includes property values which correspond to defined properties of a rich web site template. For example, the site data can be used to define how the rich web site template will be rendered in a UI, such as a browser window for example. At 308, the template author can store the rich web site template for later modification or deployment. For example, the rich web site template files (e.g., code file, property description file, a site data file, and XAML file) can be stored as a number of data structures locally and/or remotely. As an example, a template author may store the template files locally planning to implement some other feature of a rich web site template. Once complete, a rich web site template can be provided to users for use in creating a customized web site based on features of the rich web site template.

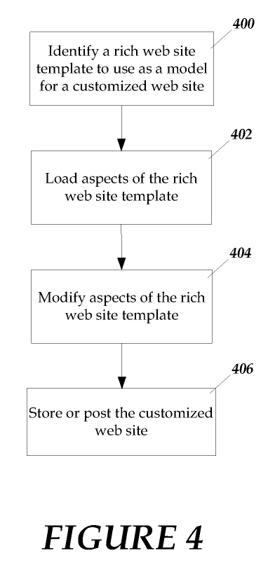

FIG. 4 is a flow diagram illustrating an exemplary process of using a rich web site template to create a customized web site. While a number and order of operations are shown and described, other embodiments are available. At 400, the user can identify a rich web site template as a model to create a customized web site. For example, a user can use a web browser to browse to a web site having a number of available rich web site templates and select a rich web site template as a model. As another example, the user may have previously downloaded and/or began modifying a rich web site template and can open the rich web site template from a local or remote storage location.

At 402, the web browser loads the rich web site template and presents aspects of the rich web site template, including presenting an editor UI (see FIGS. 5A-5B for example) based in part on a modifiable element of the rich web site template. At 404, the template user can modify aspects of the rich web site template using user-friendly controls presented with the editor UI as part of creating the customized web site. At 406, the user can save the customized web site. For example, the customized web site can be stored as one or more data structures in a local and/or a remote computer storage medium. The web site can be posted for further use by web page browsers.

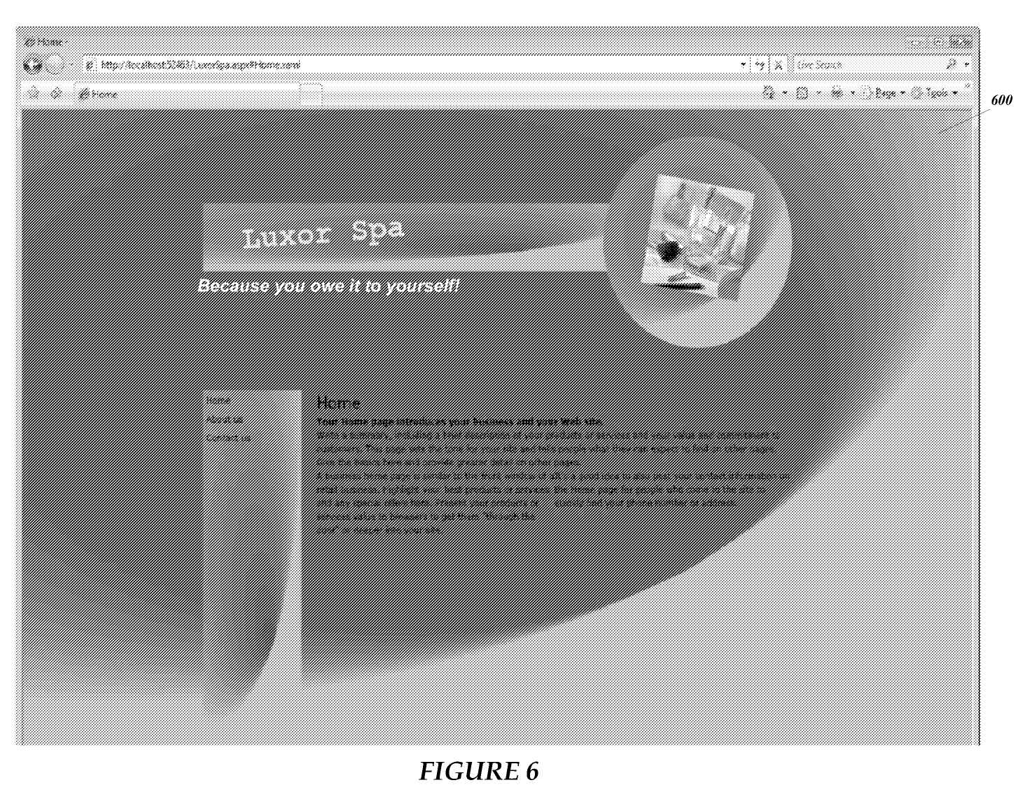

FIGS. 5A-5B depict an exemplary studio component user interface (UI) 500 that can be used to modify aspects of a rich web site template 502 in generating a customized web site (see FIG. 6).

For this example, an exemplary code component can be associated with the rich web site template and configured as:

```
    using System;
    using System.IO;
    using AuthorSDK;
    namespace LuxorSpa
    {
      public partial class LuxorMasterPage : AuthorMasterPage
      {
        public LuxorMasterPage( )
        {
          InitializeComponent( );
        }
        public LuxorMasterPage(Stream xapStream)
          : base(xapStream)
        {
          InitializeComponent( );
        }
        public void NavBtn_Click(object sender, EventArgs e)
        {
          base.NavItemClicked(sender);
        }
      }
    }
    Continuing with this example, a XAML component can be associated with the
rich web site template and configured as:
    <Author:AuthorMasterPage x:Class=“LuxorSpa.LuxorMasterPage”
      xmlns=“http://schemas.microsoft.com/winfx/xaml/presentation”
      xmlns:x=“http://schemas.microsoft.com/winfx/xaml”
      xmlns:Author=“clr-namespace: Author SDK;assembly= Author SDK”>
      <Grid x:Name=“LayoutRoot”>
        <Grid.RowDefinitions>
          <RowDefinition Height=“Auto”></RowDefinition>
          <RowDefinition Height=“*”></RowDefinition>
          <RowDefinition Height=“Auto”></RowDefinition>
        </Grid.RowDefinitions>
        <Grid.ColumnDefinitions>
          <ColumnDefinition Width=“*”></ColumnDefinition>
          <ColumnDefinition Width=“150”></ColumnDefinition>
          <ColumnDefinition Width=“630”></ColumnDefinition>
          <ColumnDefinition Width=“*”></ColumnDefinition>
        </Grid.ColumnDefinitions>
        <Canvas  Grid.Column=“1”  Grid.ColumnSpan=“2”  Height=“330”
Width=“780”>
          <Rectangle x:Name=“HeaderBar” Canvas.Top=“110” Width=“600”
Height=“80”/>
          <Ellipse x:Name=“HeaderCircle” Canvas.Left=“530” Canvas.Top=“30”
Width=“250” Height=“250”/>
          <Image  x:Name=“HeaderImage”  Height=“130”  Canvas.Top=“85”
Canvas.Left=“590”>
            <Image.RenderTransform>
              <RotateTransform x:Name=“HeaderImageRotate” CenterX=“65”
CenterY=“65”/>
            </Image.RenderTransform>
          </Image>
          <TextBlock x:Name=“SiteTitle” Canvas.Top=“130” Canvas.Left=“50”>
            <TextBlock.RenderTransform>
              <RotateTransform Angle=“−4”/>
            </TextBlock.RenderTransform>
          </TextBlock>
          <TextBlock x:Name=“SiteTagline” Canvas.Top=“200” Canvas.Left=“50”
TextAlignment=“Center”/>
        </Canvas>
        <ListBox x:Name=“NavBar” Grid.Column=“1” Grid.Row=“1”
Margin=“0,0,20,0” BorderThickness=“0”>
          <ListBox.ItemTemplate>
            <DataTemplate>
              <TextBlock  Tag=“{Binding  ContentUrl}”  Text=“{Binding
NavTitle}” MouseLeftButtonUp=“NavBtn_Click”/>
            </DataTemplate>
          </ListBox.ItemTemplate>
        </ListBox>
        <TextBlock  x:Name=“FooterText”  Grid.Column=“1”
Grid.ColumnSpan=“2”  Grid.Row=“3”  TextWrapping=“Wrap”
HorizontalAlignment=“Center”/>
      </Grid>
    </Author:AuthorMasterPage>
    Continuing with this example, a property description file can be configured as:
      <?xml version=“1.0” encoding=“utf-8” ?>
    - <PropertyGroups>
    - <PropertyGroup DisplayName=“Site header”>
      <PropertyDescription  Type=“Text”  Name=“Svelte_SiteTitle”
DisplayName=“Site title” ClickOn=“SiteTitle” BindTo=“SiteTitle” />
      <PropertyDescription  Type=“Text”  Name=“SiteTagline”
DisplayName=“Tagline” ClickOn=“SiteTagline” BindTo=“SiteTagline” />
      <PropertyDescription  Type=“Brush”  Name=“HeaderBackgroundBrush”
DisplayName=“Background”  ClickOn=“HeaderBar,HeaderCircle”
BindTo=“HeaderBar.Fill,HeaderCircle.Fill” />
      <PropertyDescription Type=“Range” Name=“HeaderImageRotate” Min=“0”
Max=“60”  DisplayName=“Header  image  angle”  ClickOn=“HeaderImage”
BindTo=“HeaderImageRotate.Angle” />
      <PropertyDescription  Type=“Image”  Name=“HeaderImage”
DisplayName=“Header image” BindTo=“HeaderImage” />
      </PropertyGroup>
    - <PropertyGroup DisplayName=“Navigation”>
      <PropertyDescription  Type=“Brush”  Name=“NavBackgroundBrush”
DisplayName=“Background” ClickOn=“NavBar” BindTo=“NavBar.Background” />
      </PropertyGroup>
    - <PropertyGroup DisplayName=“Other”>
      <PropertyDescription  Type=“Brush”  Name=“SiteBackgroundBrush”
DisplayName=“Site background” BindTo=“LayoutRoot.Background” />
      <PropertyDescription Type=“Text” Name=“FooterText” DisplayName=“Footer
text” ClickOn=“FooterText” BindTo=“FooterText” />
      </PropertyGroup>
      </PropertyGroups>
    And, for this example, exemplary site data can be configured as:
      <?xml version=“1.0” encoding=“utf-8” ?>
    - <SiteData>
    - <Pages>
      <Page Title=“Home” NavTitle=“Home” ContentUrl=“Home” />
      <Page Title=“About Us” NavTitle=“About us” ContentUrl=“Aboutus” />
      <Page Title=“Contact Us” NavTitle=“Contact us” ContentUrl=“Contactus” />
      </Pages>
      <PageContentPosition Row=“1” Column=“2” />
    - <Properties>
    - <SiteBackgroundBrush>
    - <![CDATA[  <RadialGradientBrush
            xmlns=“http://schemas.microsoft.com/winfx/xaml/presentation”
            GradientOrigin=“0.7,0.7”  Center=“0.1,0.1”  RadiusX=“.9”
RadiusY=“.8”>
            <GradientStop Color=“#AA3344” Offset=“0.5”/>
            <GradientStop Color=“#FFAA44” Offset=“1”/>
          </RadialGradientBrush>
      ]]>
      </SiteBackgroundBrush>
    - <HeaderBackgroundBrush>
    - <![CDATA[  <RadialGradientBrush
    xmlns=“http://schemas.microsoft.com/winfx/xaml/presentation”
            GradientOrigin=“0.7,0.7”  Center=“0.1,0.1”  RadiusX=“.9”
RadiusY=“.8”>
            <GradientStop Color=“Brown” Offset=“0”/>
            <GradientStop Color=“#FFAA44” Offset=“1”/>
          </RadialGradientBrush>
      ]]>
      </HeaderBackgroundBrush>
    - <NavBackgroundBrush>
    - <![CDATA[  <RadialGradientBrush
    xmlns=“http://schemas.microsoft.com/winfx/xaml/presentation”
            GradientOrigin=“0.7,0.7”  Center=“0.1,0.1”  RadiusX=“.9”
RadiusY=“.8”>
            <GradientStop Color=“Green” Offset=“0”/>
            <GradientStop Color=“#FFAA44” Offset=“1”/>
          </RadialGradientBrush>
    ]]>
    </NavBackgroundBrush>
    <Svelte_SiteTitle  Text=“Luxor  Spa”  FontFamily=“Courier  New”
FontSize=“40” FontColor=“Yellow” Bold=“True” />
    <SiteTagline Text=“Because you owe it to yourself” FontFamily=“Times New
Roman” FontSize=“20” FontColor=“Green” Italic=“True” />
    <FooterText Text=“All rights reserved.” FontFamily=“Times New Roman”
FontSize=“10” FontColor=“Black” />
    <HeaderImage Source=“/Images/a.jpg” />
    <HeaderImageRotate Value=“10” />
    </Properties>
    </SiteData>
```

With continuing reference to FIG. 5A, an associated studio component can include a studio component UI 500 to provide the web site template 502 and associated controls as defined by a template author for example based in part on one or more components, files, and/or a select modifiable property described above. As shown for this example, a text modification ribbon 504 (encircled with a lasso to identify associated tools) has been rendered by the studio component based in part on a selection detection (e.g., user click, touch, voice command, etc.) corresponding to a description area 506 (footer text) of the web site Home page. The studio component has also rendered a collapsible layout utility 508 to assist in laying out an area of the Home page.

As shown, the web site template 502 has been designed to include a number of modifiable elements: a title 510, a site tag line 512, a header bar 514, a header circle 516, an image 518. The web site template 502 has also been designed to include a number of navigation links 520. As shown for this example, the studio component UI 500 also includes tabs 522-528 corresponding to a modifiable page element or portion. As shown in FIG. 5B, a brush ribbon 530 (encircled with a lasso to identify associated tools) has been rendered by the studio component based in part on a selection detection of a background element or portion of the web site template 502. A dropdown menu 532 can also be used to interact with a modifiable portion or element of the web page template.

FIG. 6 depicts an exemplary customized web site page 600 based on the web site template 502 of FIGS. 5A-5B.

The computing environments, systems, and/or embodiments described herein can be configured to include networking, security, and/or other communication functionality to provide an interactive and communicative environment. Accordingly, the environments and components include functionality to communicate with other computing devices, communication devices, and/or other systems and are not intended to be limited to the embodiments and examples described herein. Moreover, components can be configured to communicate via a wired, wireless, and/or combination of various communication networks.

The computing environments and systems described herein can be configured as a networked environment that includes software, firmware, hardware, and other components to provide a distributed computing environment, such as a .NET or other framework for example. Additionally, while a certain number and configuration of components are described and shown, other numbers of components and configurations can be used. For example, a computing environment can include a plurality of computing devices, clients, servers, repositories, and/or other components.

### Exemplary Operating Environment

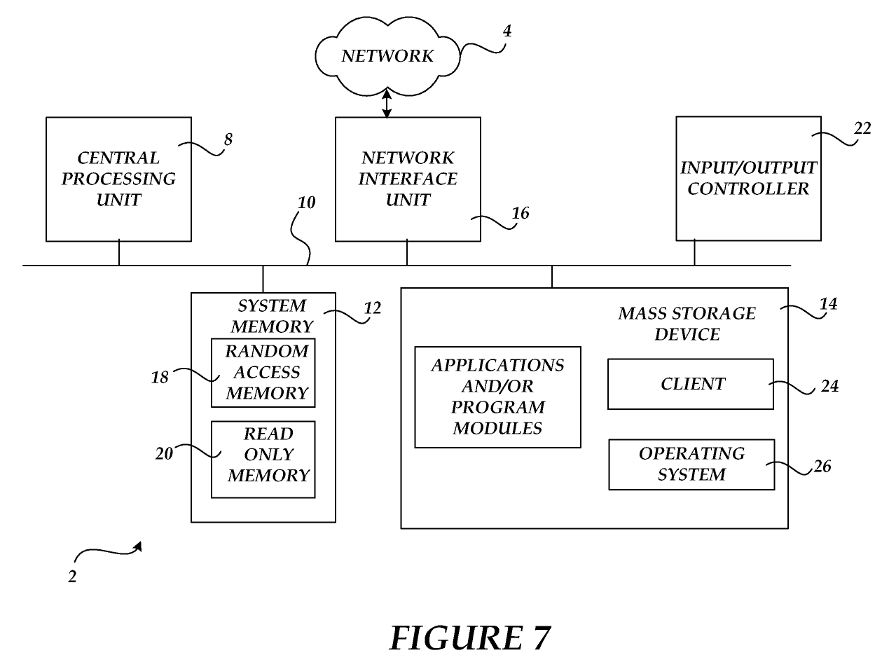

Referring now to FIG. 7, the following discussion is intended to provide a brief, general description of a suitable computing environment in which embodiments of the invention may be implemented. While the invention will be described in the general context of program modules that execute in conjunction with program modules that run on an operating system on a personal computer, those skilled in the art will recognize that the invention may also be implemented in combination with other types of computer systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Referring now to FIG. 7, an illustrative operating environment for embodiments of the invention will be described. As shown in FIG. 7, computer 2 comprises a general purpose desktop, laptop, handheld, tablet, or other type of computer capable of executing one or more application programs. The computer 2 includes at least one central processing unit 8 (“CPU”), a system memory 12, including a random access memory 18 (“RAM”) and a read-only memory (“ROM”) 20, and a system bus 10 that couples the memory to the CPU 8. A basic input/output system containing the basic routines that help to transfer information between elements within the computer, such as during startup, is stored in the ROM 20.

The computer 2 further includes a mass storage device 14 for storing an operating system 32, application programs and other program modules. The mass storage device 14 is connected to the CPU 8 through a mass storage controller (not shown) connected to the bus 10. The mass storage device 14 and its associated computer-readable media provide non-volatile storage for the computer 2. Although the description of computer-readable media contained herein refers to a mass storage device, such as a hard disk or CD-ROM drive, it should be appreciated by those skilled in the art that computer-readable media can be any available media that can be accessed or utilized by the computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 2.

According to various embodiments of the invention, the computer 2 may operate in a networked environment using logical connections to remote computers through a network 4, such as a local network, the Internet, etc. for example. The computer 2 may connect to the network 4 through a network interface unit 16 connected to the bus 10. It should be appreciated that the network interface unit 16 may also be utilized to connect to other types of networks and remote computing systems. The computer 2 may also include an input/output controller 22 for receiving and processing input from a number of input types, including a keyboard, mouse, pen, stylus, finger, and/or other means. Similarly, an input/output controller 22 may provide output to a display, a printer, or other type of output device. Additionally, a touch screen can serve as an input and an output mechanism.

As mentioned briefly above, a number of program modules and data files may be stored in the mass storage device 14 and RAM 18 of the computer 2, including an operating system 32 suitable for controlling the operation of a networked personal computer, such as the WINDOWS operating systems from MICROSOFT CORPORATION of Redmond, Wash. The mass storage device 14 and RAM 18 may also store one or more program modules. In particular, the mass storage device 14 and the RAM 18 may store application programs, such as a word processing application 28, a spreadsheet application 30, e-mail application 34, etc.

It should be appreciated that various embodiments of the present invention can be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present invention as recited within the claims set forth herein.

Although the invention has been described in connection with various exemplary embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A computing system comprising:
a processor and memory,
a design component coupled to the processor and configured to:
define a base class including a number properties and methods that can be used to define aspects of a web site template, wherein the number of methods include one or more virtual methods and each property includes a property type having a metadata attribute;
create the rich web site template including a master page that includes one or more web site template properties and methods selected from the base class;
define modifiable portions of the rich web site template based in part on one or more of the web site template properties;
associate each modifiable portion of the web site template to a corresponding modification tool; and,
store the rich web site template in memory.

2. The system of claim 1, wherein the design component is further configured to store the rich web site template with a dedicated server.

3. The system of claim 2, further comprising a studio component configured to access the web site template from the server for use in creating a customized web site.

4. The system of claim 1, further comprising a studio component configured to use the web site template to create a customized web site based in part on one of a service, product, and a theme.

5. The system of claim 4, further comprising a browser component, wherein the studio component is configured as a web-based application accessed using the browser component.

6. The system of claim 1, wherein the design component is further configured to create the rich web site template including a XAML file, a property description file, and code file.

7. The system of claim 1, wherein the design component is further configured to define the base class wherein virtual methods include an update site property method and a load navigation method.

8. The system of claim 1, wherein the design component is further configured to define the base class to include property types selected from one or more of a text property type, a number property type, an image property type, a brush property type, an audio property type, and a video property type.

9. The system of claim 8, wherein the design component is further configured to define the base class to include metadata attributes including a display name attribute, a click-on attribute, and a bind-to attribute.

10. The system of claim 1, wherein the design component is further configured to associate each modifiable portion of the web site template to a corresponding modification ribbon.

11. The system of claim 10, wherein the design component is further configured to associate one of a brush ribbon, a text ribbon, an audio ribbon, an image ribbon, and a video ribbon based in part on a corresponding property type.

12. The system of claim 11, wherein the design component is further configured to define a layout design grid for a page layout portion.

13. A computing system comprising:
a processor and memory,
a studio component coupled to the processor and configured to:
generate a rich web site using a web site template, wherein the web site template is derived from a master page that includes one or more property types selected from: a text property type, a number property type, an image property type, a brush property type, an audio property type, and a video property type, each property type having a number of attributes including a display name attribute, a click-on attribute, and a bind-to attribute; and,
store parameters of the rich web site in the memory.

14. The system of claim 13, further comprising a web browser configured to access the rich web site template from a server.

15. The system of claim 13, wherein the studio component is further configured to provide a tailored modification ribbon based on a selected property type.

16. The system of claim 13, wherein the web site template comprises a XAML file, a property description file, and a site data file.

17. A method comprising:
loading aspects of a rich web site template to be used as a model for customizing a web site, the web site template based in part on a master page that includes a number of properties including a text property, a number property, an image property, a brush property, an audio property, and a video property, wherein the web page template includes one or more of the number of properties according to a template design;
detecting a property selection of one of the number of properties of the template design;
activating an appropriate ribbon based in part on a type of property corresponding to the detected property selection;
updating the web site based in part on a modification of the property of the rich web site template; and,
storing the rich web site in a computer storage medium.

18. The method of claim 17, further comprising generating files associated with the web site template including a XAML file, a property description file, and a site data file.

19. The method of claim 18, further comprising using a virtual method to create aspects of the web site template.

20. The method of claim 17, further comprising adapting an editor UI based in part on aspects of a rich web site template.
